(19) United States
(12) Patent Application Publication
(10) Pub. No.: US 2007/0081651 A1
(43) Pub. Date: Apr. 12, 2007

(54) Method and apparatus for automatic conference call invocation based on user presence

(76) Inventors: Radha Iyer, San Jose, CA (US); Nidhi Narang, Fremont, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/239,315

(22) Filed: Sep. 28, 2005

(51) Int. Cl. H04M 3/42

(52) U.S. Cl. 379/202.01

(57) ABSTRACT

A telecommunications system includes a plurality of user devices; a presence and availability service configured to monitor presence states of the plurality of user devices; a teleconferencing service configured to permit a scheduling of conferences among the plurality of users; wherein said teleconferencing service is configured to invoke a scheduled teleconference responsive to presence states of the plurality of user devices.

### BACKGROUND OF THE INVENTION

1. Field of the Invention

The present invention relates to telecommunications systems and, in particular, to an improved teleconferencing system.

2. Description of the Related Art

Modern teleconferencing systems allow users to schedule conferences among several users at a particular time and date. Typically, a host will call in to a conferencing service to schedule the conference, receive a call-in number, and a conference identification or password. At the scheduled time, prospective participants can dial in to the service, enter their identifications, and be joined to the conference.

This method of conferencing can be problematic, however, in that it relies on each participant to remember the scheduled conference and also manually type in conference details. There is therefore a need for an improved system and method for scheduling and joining a teleconference.

### SUMMARY OF THE INVENTION

These and other drawbacks in the prior art are overcome in large part by a system and method according to embodiments of the present invention.

A method according to embodiments of the present invention includes scheduling a teleconference; specifying prospective participants in said teleconference; determining a presence status of said participants; and invoking said conference at a scheduled time based on a presence status of prospective participants. In some embodiments, the invoking includes calling out to a conference host at the scheduled time. In some embodiments, the invoking includes calling out to a conference participant at the scheduled time if at least one other participant has joined the teleconference. In some embodiments, the invoking includes calling out to prospective participants if their presence states indicate said prospective participants are available.

A telecommunications system, according to embodiments of the present invention includes a plurality of user devices; a presence and availability service configured to monitor presence states of the plurality of user devices; a teleconferencing service configured to permit a scheduling of conferences among the plurality of users; wherein said teleconferencing service is configured to invoke a scheduled teleconference responsive to presence states of the plurality of user devices.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram schematically illustrating a system according to embodiments of the present invention.

FIG. 2 is a diagram schematically illustrating a system according to embodiments of the present invention.

FIG. 3 is a diagram illustrating operation of embodiments of the present invention.

FIG. 4 is a flowchart illustrating operation of embodiments of the present invention.

FIG. 5 is a flowchart illustrating operation of embodiments of the present invention.

FIG. 6 is a diagram illustrating operation of embodiments of the present invention.

FIG. 7 is a diagram illustrating an exemplary messaging window for use in embodiments of the present invention.

FIG. 8 is a flowchart illustrating operation of embodiments of the present invention.

FIG. 9 is a diagram illustrating operation of embodiments of the present invention.

FIG. 10 is an exemplary network configuration of embodiments of the present invention.

FIG. 11 is a block diagram of a computing device according to an embodiment of the present invention.

### DETAILED DESCRIPTION OF EMBODIMENTS OF THE INVENTION

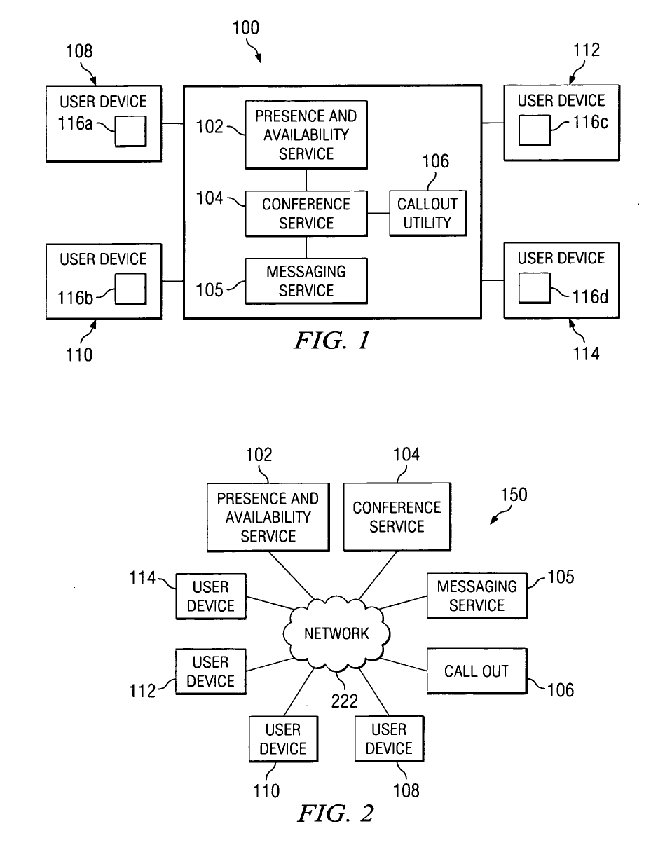

Turning now to the drawings and, with particular attention to FIG. 1, a diagram of a telecommunications system 100 according to an embodiment of the present invention is shown. The system includes a presence and availability service 102, which may include, be operably coupled to, or in communication with, a conference service 104, a messaging service 105, and a call out utility 106.

User devices, such as user devices 108, 110, 112, 114 may be operably coupled to or in communication with presence and availability service 102, conference service 104, messaging service 105 and the call out utility 106. In some embodiments, a user device may be or include such things as telephones, cellular telephones, PDAs, computers, etc. For example, the user devices 108, 110, 112, 114 may be personal computers implementing the Windows XP™ operating system. In addition, the user devices 108, 110, 112, 114 may include telephony and other multimedia messaging capability using, for example, peripheral cameras, Webcams, microphones and speakers (not shown) or peripheral telephony handsets, such as the Optipoint™ handset available from Siemens Communications, Inc.

The user devices may be equipped with server or web access portals 116a-116b, respectively, for communicating with the presence and availability service 102, the conference service 104, and the call out utility 106, as will be explained in greater detail below. The server access portal 116a-116d may also be operably coupled to, or incorporate, a telephony application or client, so as to be able to make conference calls and perform other telephony and related functions using the web access portal 116a-116d and via the telephony service 102.

Thus, the server access portals 116a-116d may provide for bi-directional communication of signaling, setup, and control for, among other things, conference calls. In certain embodiments, the server access portals 116a-116d may be embodied as web browsers, such as Microsoft Explorer, Netscape Navigator, and Mozilla Firefox, and any necessary add-ons and cooperating programs, as will be described in greater detail below.

In certain embodiments, the system 100 may also include other hardware and/or software components (e.g., gateways, proxy servers, registration server, presence servers, redirect servers, databases, applications, etc.) such as, for example, hardware and software used to support a SIP (Session Initiation Protocol) or other protocol based infrastructure for the system 100 and allow the registration of SIP devices in the system 100.

The presence and availability service 102 may be or include an application that monitors the presence and availability of devices. That is, the presence and availability service 102 monitors the presence context of one or more devices. Context for a device may describe the work or non-work state, and/or the availability or non-availability state that the device is in. In some embodiments, potential contexts may include “available,” “non-available,” “busy,” “away,” “unknown,” “partially available” (e.g., a device may be “busy” on a voice channel but available on an instant messaging channel), “be right back,” “present,” not present,” etc. The presence and availability service 102 may be implemented in software operating on one or more servers, computer systems, host or mainframe computers, workstations, etc. In some embodiments the presence and availability service 102 may be operating on some or all of the same device(s) as other components in the system 100.

In some embodiments, the presence and availability service 102 may be or include an application that communicates with or is connected to one or more registered devices (e.g., devices 108, 110, 112, 114), that allows devices to register with the system 100 or helps facilitate their registration, etc. For example, in a SIP environment, the devices 108, 110, 112, 114 may be registered with the system 100 and may show up or be described in registration databases as being assigned to particular identities.

The conference service 104 allows the user to make and set up conference telephone calls. Thus the conference service 104 includes any necessary switching and mixing control, as well as scheduling capabilities. The conference service 104 may be implemented in hardware and/or software operating on one or more servers, computer systems, host or mainframe computers, workstations, etc. In some embodiments, the conference service 104 may be operating on some or all of the same devices as other components in the system 100.

The messaging service 105 may be implemented as one or more messaging systems, such as e-mail, instant messaging, SMS, etc. In some embodiments, it may operate as one or more commands in a web browser that allow pop up windows to be displayed at a user device responsive to signaling from other users or systems. The messaging service 105 may be implemented in hardware and/or software operating on one or more servers, computer systems, host or mainframe computers, workstations, etc. In some embodiments, the messaging service 105 may be operating on some or all of the same devices as other components in the system 100.

The call out utility 106, which may be embodied as part of a general telephone service, provides for calling out to and connecting designated parties. For example, a user can specify a telephone and a called party in his browser portal 116. The call out utility 106 will then call out to the called party telephone, and to the user's telephone, connecting the parties. The call out utility 106 may be implemented in hardware and/or software operating on one or more servers, computer systems, host or mainframe computers, workstations, etc. In some embodiments, the call out utility 106 may be operating on some or all of the same devices as other components in the system 100.

In certain embodiments of the present invention, one or more of the components of the system 100 may be connected to or in communication with each other via a communication network. For example, turning now to FIG. 2, a system 150 including various components of the system 100 is illustrated, wherein some or all of the components are in communication via a network 222. The network 222 may be or include the Internet, World Wide Web, a local area network, or some other public or private computer, cable, telephone, client/server, peer-to-peer, or communication network or intranet. In some embodiments, the communication network can also include other public and/or private wide area networks, local area networks, wireless networks, data communications networks, or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 222 may be implemented using a TCP/IP network and may implement voice or multimedia over IP using, for example, the Session Initiation Protocol (SIP).

An exemplary environment capable of being adapted for use in a system according to embodiments of the present invention is the OpenScape multimedia and presence system, available from Siemens Communications, Inc. Such an environment can be implemented, for example, in conjunction with Windows Server, Microsoft Office Live Communications Server, Microsoft Active Directory, Microsoft Exchange and SQL Server.

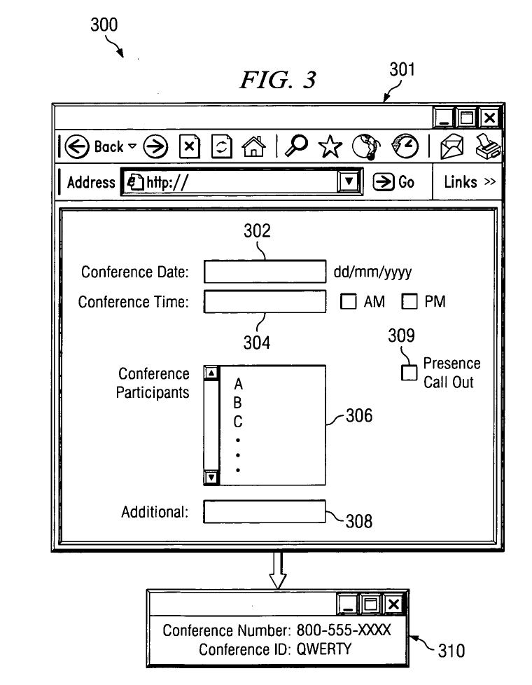

Turning now to FIG. 3, a diagram schematically illustrating operation of an embodiment of the present invention is shown. In particular, shown are various windows 300 that may be generated, for example, by a web browser or user portal 116 on a personal computer. The web browser 116 may be used, for example, to access a conference service 104 on a server. Window 301 illustrates an exemplary conference setup window.

Shown in window 301 is a conference date entry panel 302, a conference time entry panel 304, conference participant dialogs 306 and 308, and presence call out selection 309. In operation, a user may enter a conference date and conference time, for example, using a computer keyboard, into the respective panels 302, 304. In addition, the user can select conference participants from dialog 306, for example, using a cursor pointing device such as a mouse. In certain embodiments, selecting the conference participants can include selecting their contact telephone numbers. In some embodiments, it can also include selecting the participants' messaging service identity, e.g., an e-mail address for receiving messages related to the conference. In addition, the user can select presence call out functionality according to embodiments of the present invention using dialog 309.

Once the conference details have been selected, the system may provide the user with a separate window 310, that includes the conference dial in number and the conference identification. As will I be discussed in greater detail below, at the designated time, if the presence based call out was enabled, the conference service 104 will communicate with the presence and availability service 102 to determine participants' presence states, and the call out service 106 to call and join those participants who are determined to be present or available.

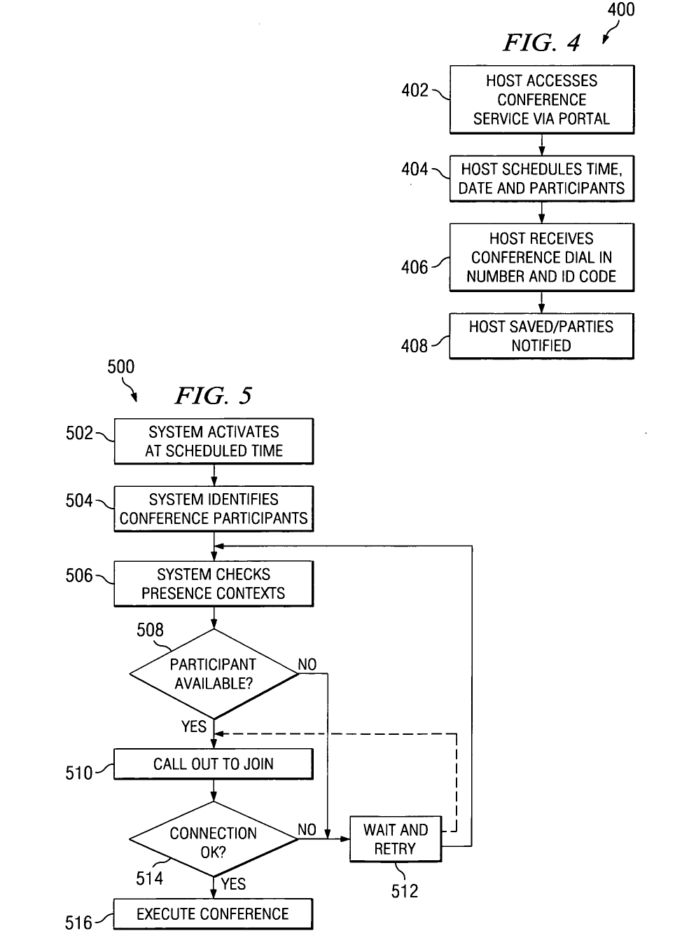

Turning now to FIG. 4, a flowchart 400 illustrating operation of an embodiment of the present invention is shown. The particular arrangement of elements in the flowchart 400 is not meant to imply a fixed order to the elements; embodiments can be practiced in any order that is practicable.

Initially, in a step 402, a host user can access the conference service 104 via the user portal 116. In a step 404, the host user can use the portal 116 to schedule the time and date of the conference, as well as the identities and numbers of the conference participants. In some embodiments, the host can also select automatic presence call out; in other embodiments, this may be a default for conference configuration. In addition, in certain embodiments, the host user can also identify himself as the host of the conference. Alternatively, this information may be determined by the system (i.e., by identifying the user who has scheduled the conference). Next, in a step 406, the host user receives the conference number and the conference code. Finally, in a step 408, the host can save the information. In addition, in certain embodiments, the participants may be notified via messaging system 105 about the conference. That is, once the host has set up the conference, participants could receive an e-mail or browser pop-up message indicating that a conference has been scheduled.

In addition, in some embodiments, in addition to the host, each participant can have an option to enable or disable the presence based callout for the conference. That is, in some embodiments, each user can log in to the conference service 104, for example, using his portal 116 and enable or disable presence based callout. If the user disables presence based call out, the system can either automatically call out to the participant regardless of his presence state or can simply wait for him to dial in manually.

Turning now to FIG. 5, a flowchart 500 illustrating operation of an embodiment of the present invention is shown. The particular arrangement of elements in the flowchart 500 is not meant to imply a fixed order to the elements; embodiments can be practiced in any order that is practicable.

In a step 502, the conference service 104 identifies the scheduled conference time and activates. In a step 504, the conference service 104 identifies the conference participants. In a step 506, if the host (and/or participant) has enabled presence based conference callout, the conference service 104 communicates with the presence and availability service 102 to determine the presence states of the conference participants. In a step 508, the presence and availability service 102 determines if the participant is available. If the participant is available, then in a step 510, the conference service 104 will communicate with the call out utility 106 to call out to the participant and join the conference. If the participant is not available, then in a step 512, the conference service 102 will wait a predetermined interval and then try again. This can include, for example, the conference service 104 checking the presence and availability service 102 again for an update on the participant's presence state, or it can simply include the conference service 104 causing the call out utility 106 to attempt to call out to the participant.

Once the call out has occurred, the participant on the other end can be connected or if not actually available, may not be. If the connection is made, as determined in a step 514, then the participant can be joined and the conference executed, in a step 516. Otherwise, in step 512, the system can again wait and retry.

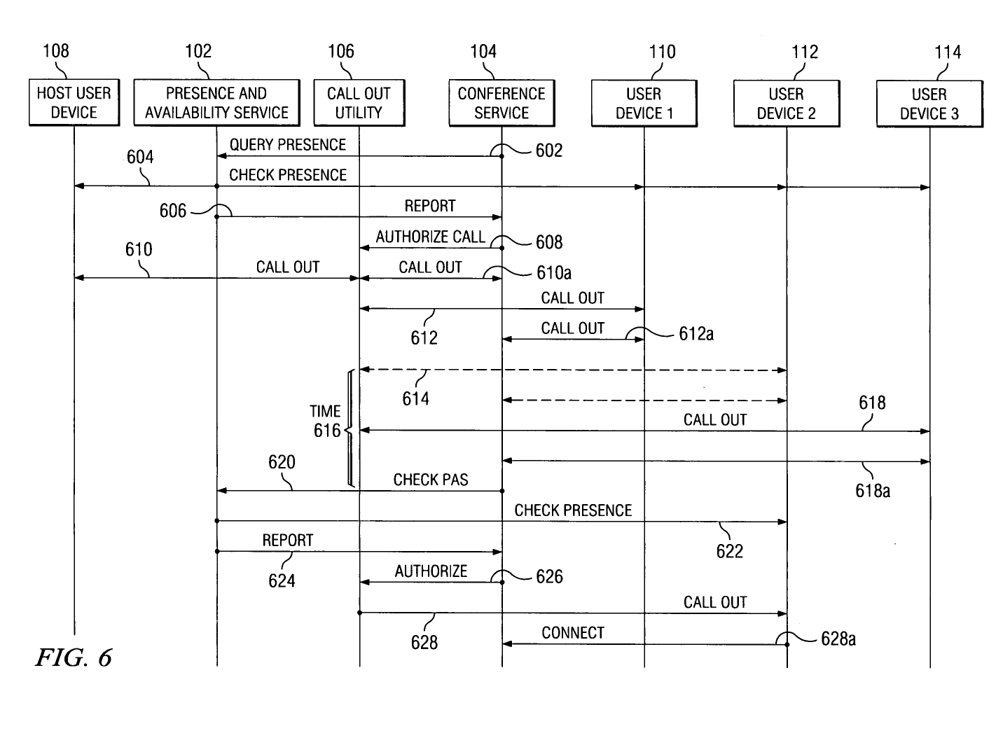

Turning now to FIG. 6, a signaling diagram illustrating operation of an embodiment of the present invention by way of example is shown. Shown are a host user device 108, user devices 110, 112, and 114, as well as the presence and availability service 102, call out utility 106, and conference service 104.

Initially, at 602, at the time scheduled for a conference, the conference service 104 queries the presence and availability service 102 for presence information on the conference participants for those participants for whom presence callout is enabled. At 604, the presence and availability service 102 can read or otherwise monitor its presence status indicia for the conference participants. At 606, the presence and availability service 102 can report the presence status of the conference participants to the conference service 104. At 608, the conference service 102 can authorize the call out utility 106 to call out to those participants who are determined to be present or “available” at their conference locations. In this example, all users are determined to have a presence state of “available.” If a user did not, then, as discussed above, the system could wait a predetermined period before checking the presence status again or before trying to call out to the user.

At 610, the call out utility 106 calls out to the host user 108; in the example illustrated, the host is available and thus is connected to the conference service at 610a. It is noted that this order is exemplary only; the host need not be the first participant joined. Similarly, the call out utility 106 calls out to the user device 110 at 612; user 110 is available, so is connected to the conference at 612a. At 614, however, user 112 is not actually available, so the call out fails. At 616, a retry timer (maintained, for example, by the conference service 104) begins timing. At 618, the call out utility 106 calls out to the user device 114; user 114 is available, so is connected to the conference at 614a. At 620, the timer can expire, and the conference service 104 can check with the presence and availability service 102 again. At 622, the presence and availability service 102 checks the presence state of the user 112 and reports to the conference service at 624. At 626, the conference service can authorize the call out utility 106 to call out to the user 112, which occurs at 628. In the example illustrated, user 112 is now actually available and this is connected to the conference at 628a. It is noted that, in other embodiments, the system could call out to the user upon expiration of the timer, rather than again checking-the presence status.

In certain embodiments of the present invention, the conference service 104 can be implemented to cause the conference to be joined only after the moderator or host or another party is joined. That is, in such an embodiment, the conference service 104 attempts to join the host (if present) and then attempts to join other members. If there is no host (or other participant present), other parties attempting to be joined can be given the option to join on stand-by or be called later.

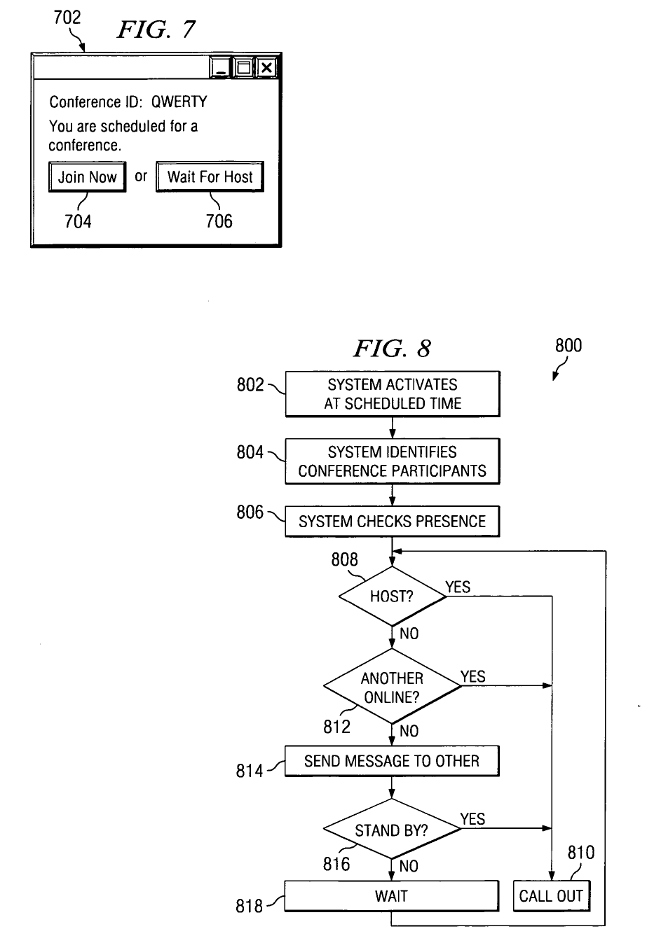

FIG. 7 is a diagram illustrating an exemplary message 702 that may be sent by a messaging service 105 or as a browser pop-up in response to the offer to join on stand by. In particular, window 702 identifies the conference and provides the option of joining now 704 or waiting for the host 720. If the user selects stand by he will be joined to the conference; if he elects to wait, he will be joined after the host is joined or after a predetermined time expires.

This is illustrated more particularly with reference to the flowchart 800 of FIG. 8, illustrating operation of an embodiment of the present invention. The particular arrangement of elements in the flowchart 800 is not meant to imply a fixed order to the elements; embodiments can be practiced in any order that is practicable.

In a step 802, the conference service 104 identifies the scheduled conference time and activates. In a step 804, the conference service 104 identifies the conference participants. In a step 806, if the host (and/or participant) has enabled presence based callout, the conference service 104 communicates with the presence and availability service 102 to determine the presence states of the conference participants. In a step 808, the conference service 104 checks if a particular user is the host. If so, then in a step 810, the conference service 104 causes the call out utility 106 to call out to the host. If the party is not the host, the conference service 104 will check to see if another user is online, in a step 812. If there is another party online, then the party will be called to by the call out utility 106, and can be joined to the conference. If there is not another party online, then, in a step 814, the user can be sent a message asking whether he wishes to wait or join on stand by. If he selects stand by in step 816, then he will be called out to in step 810; otherwise, in step 818, the system may wait a predetermined period before checking again, or until it detects the presence of another party, who may be the host or a party on stand by.

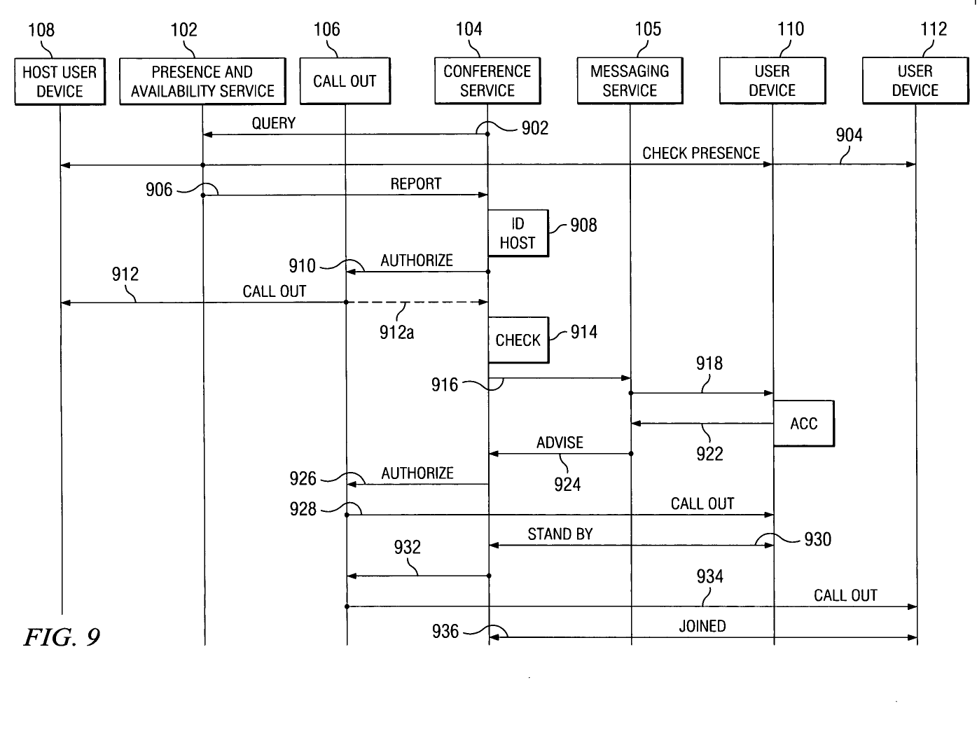

Turning now to FIG. 9, a diagram illustrating exemplary signaling flow for a particular implementation of the present invention is shown. Shown are a host user device 108, user devices 110, 112, and 114, as well as the presence and availability service 102, call out unit 106, and conference service 104. Also shown is a messaging service 105, that may be implemented, for example, as e-mail or instant messaging, or as a browser pop up.

Initially, at 902, the conference service 104 can query the presence and availability service 102 for presence information on the conference participants for whom presence based callout is enabled. At 904, the presence and availability service 102 can review the presence status of the participants and, at 906, can report back to the conference service. At 908, the conference service 104 can identify the host participant and, at 910, can authorize the call out utility 106 to call out to the host to join the conference. At 912, the call out utility 106 calls out to the host user 108; in the example illustrated, the call out fails, as shown at 912a.

At 914, the conference service 104 checks to see if any parties have joined the conference. Since no parties and, particularly, the host has not joined, at 916 the conference service 104 will communicate with the messaging service 105. The messaging service 105 will send a message to a user device 110 at 918, either informing him that he will be called momentarily, or asking whether he wishes to join the conference on stand by. As noted above, the message itself may take a variety of forms, including e-mail and web browser pop-up. At 920, the user can elect to join the conference, which is received at the messaging service 105 at 922. This is communicated to the conference service 104 which authorizes the call out service 106 to call out to the user at 926. At 928, the call out utility 106 does so, and at 930, the user device 110 can join on stand by. At 932, since at least one party has joined, the conference service 104 can authorize the call out service 106 to call out to the remaining participant 112, which does so at 934. Participant 112 can then join the conference at 936. (The host user can be retried, as well, in a manner similar to that discussed above).

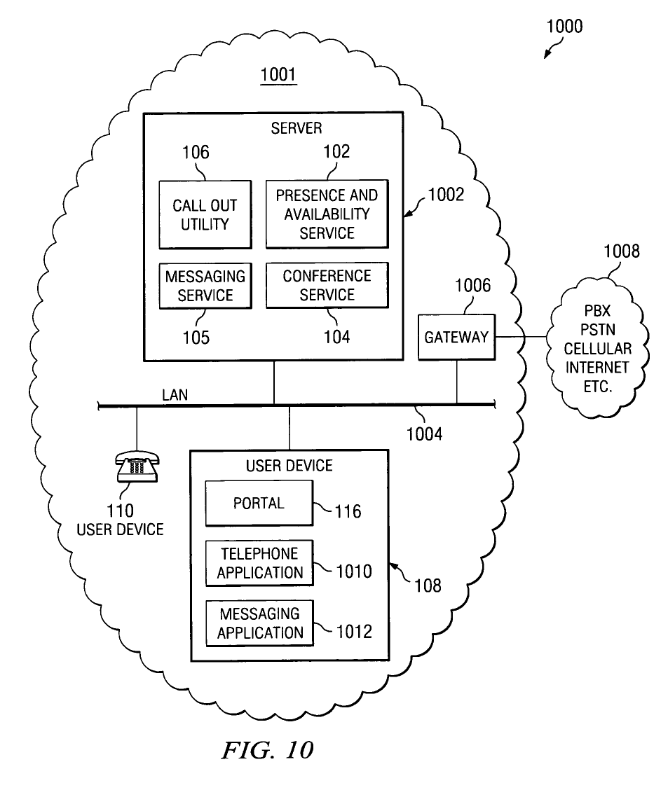

An exemplary network architecture that may be suitable for use with embodiments of the present invention is shown in FIG. 10. As shown, the system 1000 includes an enterprise network 1001 and a public network 1008. The enterprise network 1001 may include a wired or wireless local area network (LAN) 1004. A server 1002 may be coupled to the LAN 1004. The server may implement a presence and availability service 102, a conference service 104, a call out/telephony service 106, and a messaging service 105.

Also coupled, connected to, or in communication with the LAN 1004 may be one or more user devices 108, 110. The user devices 108, 110 may be implemented as personal computers 108 or digital telephones 110, such as Internet Protocol (IP) based digital telephones. An exemplary personal computer 110 may also include a browser portal 116 and a telephony client 1010 and a messaging application 1012.

A gateway 1006 may also be coupled to the LAN 1004. The gateway 1006 provides an interface to the public network 1008, which may be implemented, for example, as one or more of the PSTN, cellular telephone network, Internet, one or more PBX's, and the like. One or more telephony devices (not shown) may be in communication with the public network 908.

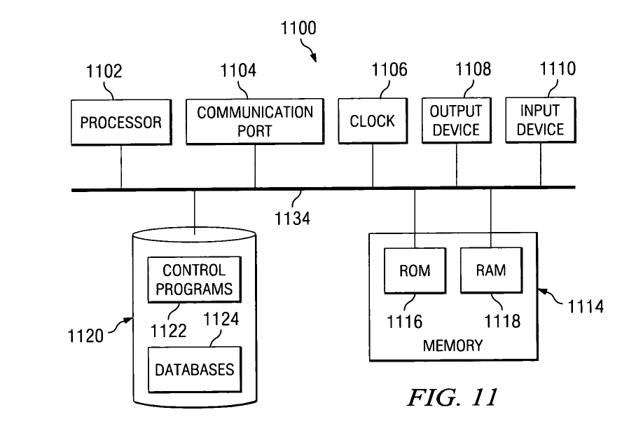

Now referring to FIG. 11, a representative block diagram of a computer or processing device 1100 suitable for use as a user device or server according to embodiments of the present invention is shown.

In some embodiments, the processing device 1100 may be embodied as a single device or computer, a networked set or group of devices or computers, a workstation, mainframe or host computer, etc. In some embodiments, the processing device 1100 may implement one more elements of the methods disclosed herein.

The processing device 1100 may include a processor, microchip, central processing unit, or computer 1102 that is in communication with or otherwise uses or includes one or more communication ports 1104 for communicating with user devices and/or other devices. The communication ports 1104 may include such things as local area network adapters, wireless communication devices, telephone network adapters, Bluetooth technology, etc. The processing device 1100 also may include an internal clock element 1108 to maintain an accurate time and date for the processing device 1100, create time stamps for communications received or sent by the processing device 1100, etc.

If desired, the processing device 1100 may include one or more output devices 1108 such as a printer, infrared or other transmitter, antenna, audio speaker, display screen or monitor, text to speech converter, etc., as well as one or more input devices 1110 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the processing device 1100 may include a memory or data storage device 1120 to store information, software, databases, documents, communications, device drivers, etc. The memory or data storage device 1120 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The processing device 1100 also may include memory 1114, such as ROM 1116 and RAM 1118.

The processor 1102 and the data storage device 1120 in the processing device 1100 each may be, for example: (i) located entirely within a single computer or other computing device; or (ii) connected to each other by a remote communication medium, such as a serial port cable, telephone line or radio frequency transceiver. In one embodiment, the processing device 1100 may be implemented as one or more computers that are connected to a remote server computer for maintaining databases.

A conventional personal computer or workstation with sufficient memory and processing capability may be used as the processing device 1100. The processing device 1100 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 1102. Other suitable processors may be available from Motorola, Inc., AMD, or Sun Microsystems, Inc. The processor 1102 also may be embodied as one or more microprocessors, computers, computer systems, etc.

Software may be resident and operating or operational on the processing device 1100. The software may be stored on the data storage device 1120 and may include one or more control programs 1122 for operating the device, databases, etc.

The control programs 1122 may control the processor 1102. The processor 1102 may perform instructions of the control programs, and thereby operate in accordance with the methods described in detail herein. The control programs may be stored in a compressed, uncompiled and/or encrypted format. The control programs furthermore include program elements that may be necessary, such as an operating system, a database management system and device drivers for allowing the processor 1102 to interface with peripheral devices, databases, etc. Appropriate program elements are known to those skilled in the art, and need not be described in detail herein.

The processing device 1100 also may include or store information regarding identities, user devices, communications, etc., in database(s) 1124. Information regarding other application program data may be stored in application database (not shown). In some embodiments, some or all of one or more of the databases may be stored or mirrored remotely from the processing device 1100.

According to some embodiments, the instructions of the control program may be read into a main memory from another computer-readable medium, such as from the ROM 1116 to the RAM 1118. Execution of sequences of the instructions in the control program causes the processor 1102 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 1102, communication ports 1104, clock 1108, output device 1108, input device 1110, data storage device 1112, ROM 1116, and RAM 1118 may communicate or be connected directly or indirectly in a variety of ways. For example, the processor 1102, communication ports 1102, clock 1108, output device 1108, input device 1110, data storage device 1112, ROM 1116, and RAM 1116 may be connected via a bus 1134.

While specific implementations and hardware/software configurations for the processing device 1100 have been illustrated, it should be noted that other implementations and hardware configurations are possible and that no specific implementation or hardware/software configuration is needed. Thus, not all of the components illustrated in FIG. 11 may be needed for the processing device 1100 implementing the methods disclosed herein.

The methods described herein may be embodied as one or more computer programs developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. The drawings are not necessarily to scale and illustrate the device in schematic block format. It is intended that the scope of the invention be defined by the claims appended hereto, and their equivalents

What is claimed is:

1. A method, comprising:
scheduling a teleconference;
specifying prospective participants in said teleconference;
determining a presence status of said participants; and
invoking said conference at a scheduled time based on a presence status of prospective participants.

2. A method in accordance with claim 1, said invoking comprising calling out to a conference host at the scheduled time.

3. A method in accordance with claim 1, said invoking comprising calling out to a conference participant at the scheduled time if at least one other participant has joined the teleconference.

4. A method in accordance with claim 1, wherein said invoking comprises calling out to prospective participants if their presence states indicate said prospective participants are available.

5. A method in accordance with claim 5, further comprising retrying to call a prospective participant after a predetermined interval if said prospective participant was not available.

6. A method in accordance with claim 3, further comprising providing a message to a prospective participant if no prospective participants are available.

7. A method in accordance with claim 6, further comprising providing an option for a prospective participant to join the teleconference in a standby mode.

8. A telecommunications system, comprising:
a plurality of user devices;
a presence and availability service configured to monitor presence states of the plurality of user devices;
a teleconferencing service configured to permit a scheduling of conferences among the plurality of users;
wherein said teleconferencing service is configured to invoke a scheduled teleconference responsive to presence states of the plurality of user devices.

9. A telecommunications system in accordance with claim 8, wherein said teleconferencing service is configured to invoke said teleconference by calling out to a conference host at the scheduled time.

10. A telecommunications system in accordance with claim 8, wherein said teleconferencing service is configured to invoke said teleconference by calling out to a conference participant at the scheduled time if at least one other participant has joined the teleconference.

11. A telecommunications system in accordance with claim 8, wherein said teleconferencing service is configured to invoke said teleconference by calling out to prospective participants if their presence states indicate said prospective participants are available.

12. A telecommunications system in accordance with claim 11, wherein said teleconferencing service is configured to retry to call a prospective participant after a predetermined interval if said prospective participant was not available.

13. A telecommunications system in accordance with claim 10, wherein said teleconferencing service is configured to provide a message to a prospective participant if no prospective participants are available.

14. A telecommunications system, comprising:
a presence and availability service configured to monitor presence states of a plurality of users;
a teleconferencing service configured to permit a scheduling of conferences among the plurality of users;
wherein said teleconferencing service is configured to invoke a scheduled teleconference responsive to presence states of the plurality of users.

15. A telecommunications system in accordance with claim 14, wherein said teleconferencing service is configured to invoke said teleconference by calling out to a conference host at the scheduled time.

16. A telecommunications system in accordance with claim 14, wherein said teleconferencing service is configured to invoke said teleconference by calling out to a conference participant at the scheduled time if at least one other participant has joined the teleconference.

17. A telecommunications system in accordance with claim 14, wherein said teleconferencing service is configured to invoke said teleconference by calling out to prospective participants if their presence states indicate said prospective participants are available.

18. A telecommunications system in accordance with claim 17, wherein said teleconferencing service is configured to retry to call a prospective participant after a predetermined interval if said prospective participant was not available.

19. A telecommunications system in accordance with claim 16, wherein said teleconferencing service is configured to provide a message to a prospective participant if no prospective participants are available.

20. A method, comprising:
invoking a teleconference at a scheduled time based on a presence status of prospective participants.

21. A teleconferencing service configured to invoke a scheduled teleconference responsive to presence states of a plurality of user devices.
